(19) United States
(12) Patent Application Publication
(10) Pub. No.: US 2007/0027626 A1
(43) Pub. Date: Feb. 1, 2007

(54) Bluetooth GPS receiver with electronic compass

(75) Inventor: Chii Moon Liou, Chunghe City (TW)

Correspondence Address: LEONG C LEI, PMB # 1008, 1867 YGNACIO VALLEY ROAD, WALNUT CREEK, CA, 94598, US

(73) Assignee: HAICOM ELECTRONICS CORP.

(21) Appl. No.: 11/193,508

(22) Filed: Aug. 1, 2005

(51) Int. Cl. G01C 21/00

(52) U.S. Cl. 701/213

(57) ABSTRACT

A Bluetooth GPS receiver with an electronic compass is provided. The GPS receiver contains a main electronic member, a front frame member, a back frame member, a battery module, a front cover, and a battery cover. The main electronic member has a satellite antenna in the front. Around the circumference of the satellite antenna, a number of dual-color LEDs are configured. Based on the Earth's magnetic field, the LEDs corresponding to the north and south poles are lit in appropriate colors for direction indication. On a top portion of the main electronic member, there are Bluetooth and power status LEDs whose lights are guided to the front by light pipes on the front frame member. The LED corresponding to the due south is lit in color green and the opposite LED corresponding to the due north is lit in color red. The two lit LEDs are always lined up and opposite to each other.

### BACKGROUND OF THE INVENTION

(a) Technical Field of the Invention

The present invention generally relates to GPS receivers supporting Bluetooth-based communications, and more particularly to such a GPS receiver having an electronic compass containing a number of dual-colored LEDs for direction indication.

(b) Description of the Prior Art

A conventional Bluetooth Global Positioning System (GPS) receiver usually contains a Bluetooth module, a GPS satellite receiver module, and a battery module. The GPS satellite receiver module receives radio signals from GPS satellites and delivers the received information to a notebook computer or a Personal Digital Assistant (PDA) via wireless transmission according to the Bluetooth protocol. Accompanied with an electronic map in the notebook computer or the PDA, a user could use the received GPS information for navigation and positioning. However, even though the conventional GPS receiver and the electronic map help pin-pointing the exact location of the user, the user still lacks the capability to identify the directions.

### SUMMARY OF THE INVENTION

The primary purpose of the present invention is to provide a Bluetooth GPS receiver with an electronic compass. The electronic compass contains a number of dual-color light emitting diodes (LEDs) for direction indication by lighting the LEDs pointing to the due south and the due north in different colors.

Another objective of the present invention is to provide a Bluetooth GPS receiver with an electronic compass, which contains a display device for showing the various directions.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective explosive view showing the various components of an embodiment of the present invention.

FIG. 2 is a perspective view showing the embodiment of FIG. 1 after it is partially assembled.

FIG. 3 is a perspective view showing the embodiment of FIG. 1 after it is fully assembled.

FIG. 4 is a front view showing the embodiment of FIG. 1 before it is turned on.

FIG. 5 is a front view showing an application scenario of the embodiment of FIG. 1 after it is turned on.

FIG. 6 is a front view showing an application scenario of the embodiment of FIG. 1 after it is turned on and rotated.

FIG. 7 is a front view showing another embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

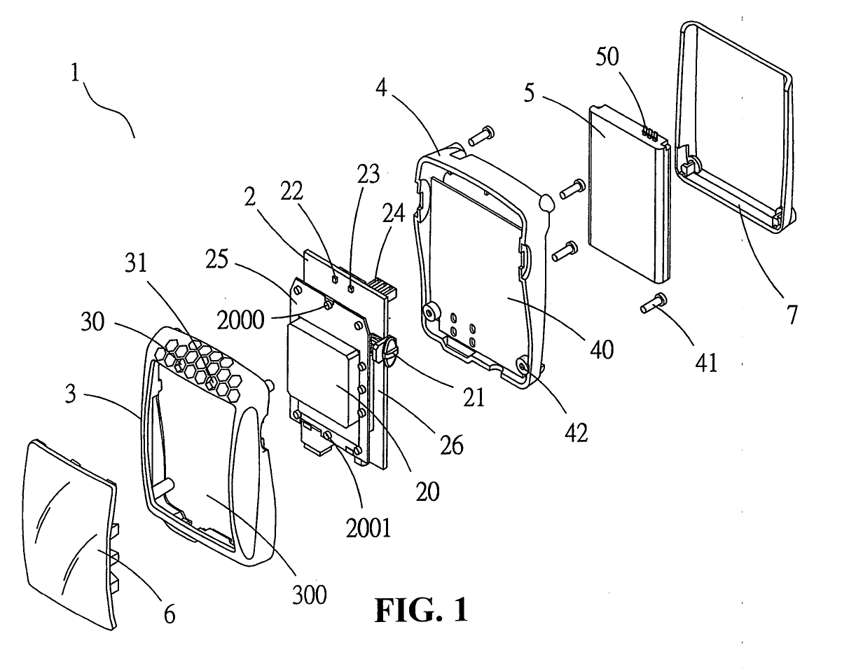

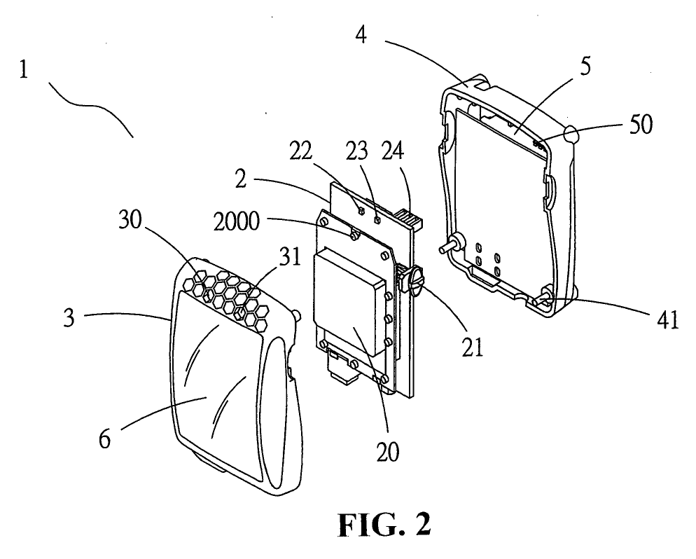

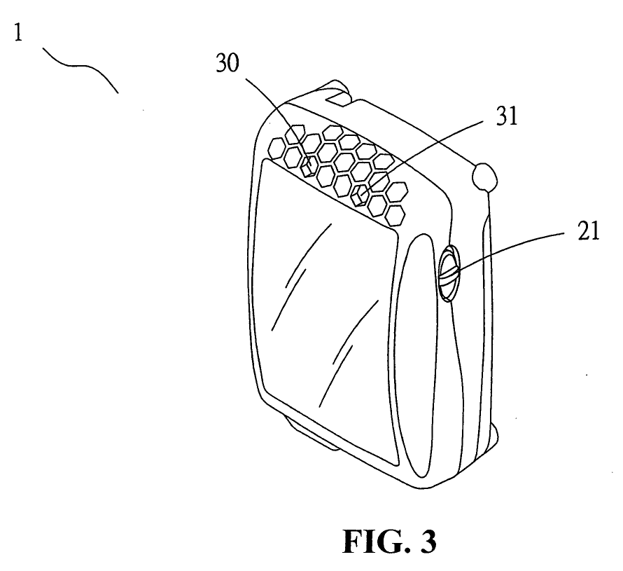

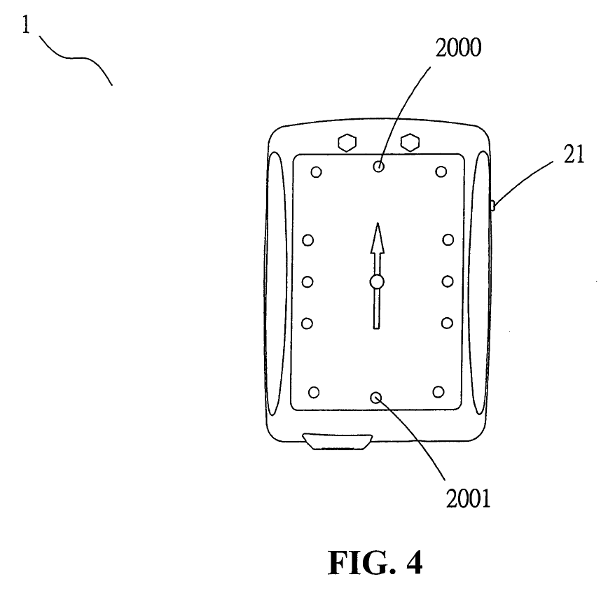

Please refer to FIGS. 1 to 5. A GPS receiver 1 according to an embodiment of the present invention mainly contains a main electronic member 2, a front frame member 3, a back frame member 4, a battery module 5, a front cover 6, and a battery cover 7. The main electronic member 2 mainly contains an electronic compass module 25, a GPS satellite receiver and Bluetooth module 26, and a satellite antenna 20, sequentially stacked and assembled together from back to front in the foregoing order. Around the circumference of the satellite antenna 20, a number of LEDs 2000, 2001, 2002, 2003 (see FIGS. 4 to 6) are configured, each of which is capable of emitting lights in at least two colors. The electronic compass module 25, based on the Earth's magnetic field, lights the LEDs corresponding to the north and south poles in appropriate colors for direction indication. For example, the LED pointing to the due south is lit in green color and the one pointing to the due north is lit in red color. On a side of the main electronic member 2, there is a power on/off switch 21. On a top portion of the main electronic member 2, there are status LEDs 22 and 23 for showing the Bluetooth operation status and whether the power is turned on. On the top portion of the front frame member 3 corresponding to the location of status LEDs 22 and 23, there are light pipes 30 and 31 for extracting and guiding lights from the status LEDs 22 and 23 to the front of the GPS receiver 1 for visibility. The main electronic member 2 is housed in a compartment 40 of the back frame member 4 and locked in its position by fixedly joining the front frame member 3 to the back frame member 4 via a number of bolts 41 screwed through the bolt holes 42. The transparent front cover 6 is embedded in a through opening 300 of the front frame member 3. The battery module 5 is positioned in the back of the back frame member 4 and covered by the battery cover 7. On top of the battery module 5, there is a power connector 50 for establishing electrical contact with another power connector 24 in the back of the main electronic member 2 for the provision of electrical power to the main electronic member 2.

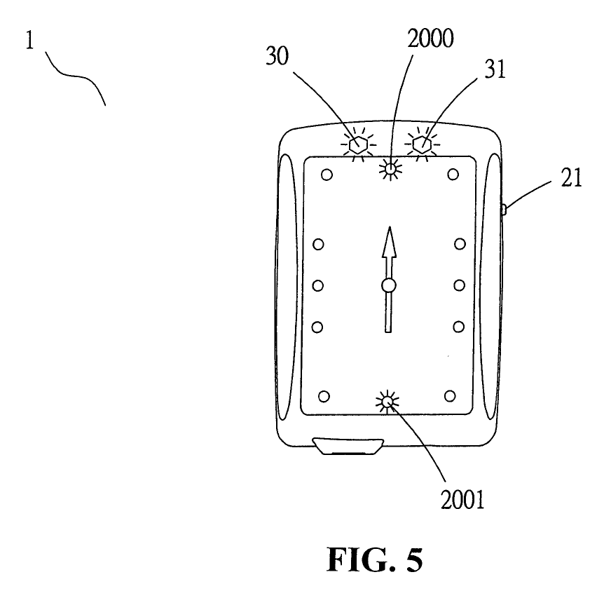

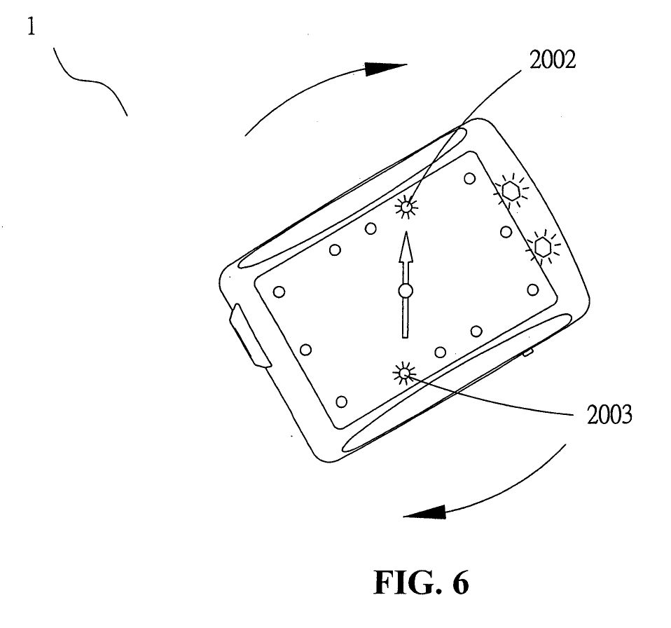

For an application scenario, please refer to FIGS. 5 and 6. Assuming that a user holding the GPS receiver 1 as shown in FIG. 5 is facing toward the due south, the LED 2000 is lit in green color while the LED 2001 is lit in red color. If the user is turned somewhat to his or her right-hand side, the LED 2002 is now corresponding to the due south and is lit in color green and the opposite LED 2003, corresponding to the due north, is lit in color red. Please note that, no matter how the user turns, only the two opposite and lined-up LEDs corresponding to the due south and the due north would be lit.

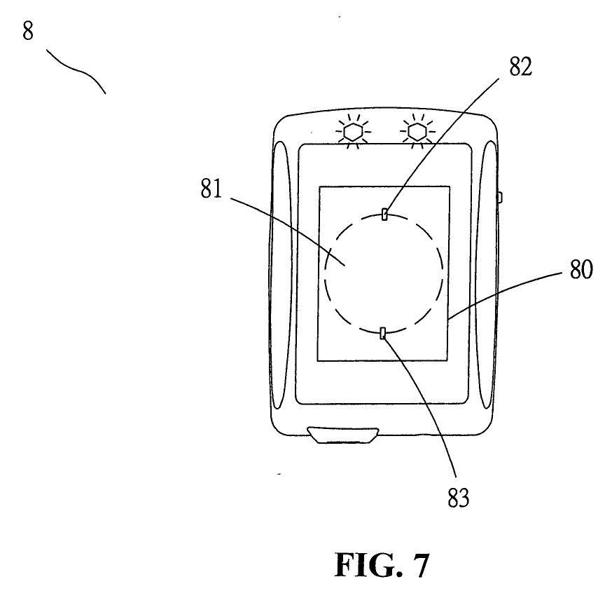

FIG. 7 is a front view showing another embodiment of the present invention. As illustrated, instead of using LEDs, a GPS receiver 8 according to the present embodiment employs a display device 80 for direction indication. The display device 80 shows a number of indicators arranged in a circle. When the GPS receiver 8 is turned, the indicators 82 and 83 pointing to the due south and the due north are lit. The two indicators lit are always lined up and opposite to each other.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A Bluetooth GPS receiver with an electronic compass, comprising:
a main electronic member capable of receiving GPS satellite radio signals and transmitting received information using Bluetooth protocol comprising an electronic compass module and a satellite antenna in the front;
a plurality of LEDs configured on said main electronic member along the circumference of said satellite antenna;
a power switch configured at a side of said main electronic member;
a plurality of Bluetooth and power status LEDs configured on a top portion of said main electronic member, whose lights are extracted and guided to the front by light pipes of said front frame member;
a battery module positioned in the back of said back frame member and covered by said battery cover, said battery module having a first power connector at the top for establishing electrical contact with a second power connector in the back of said main electronic member through which the power of said battery module is supplied to said main electronic member.

2. The Bluetooth GPS receiver according to claim 1, wherein said LEDs is capable of emitting lights in at least two colors, and the LED corresponding to the due south is lit in a first color and the LED corresponding to the due north is lit in a second color, the two lit LEDs are always lined up and opposite to each other.

3. A Bluetooth GPS receiver with an electronic compass, comprising a main electronic member capable of receiving GPS satellite radio signals and transmitting received information using Bluetooth protocol, said main electronic member comprising a display device, said display device showing a plurality of indicators arranged in a circle, two of said indicators lit to indicate the due south and the due north respectively, said two indicators always lined up and opposite to each other.
